(19) United States
(12) Patent Application Publication
(10) Pub. No.: US 2025/0002252 A1
(43) Pub. Date: Jan. 2, 2025

(54) UNMANNED TRANSPORT VEHICLE

(71) Applicant: NAKANISHI METAL WORKS CO., LTD., Osaka-shi (JP)

(72) Inventor: Shu MATSUMOTO, Osaka-shi (JP)

(73) Assignee: NAKANISHI METAL WORKS CO., LTD., Osaka-shi (JP)

(21) Appl. No.: 18/737,487

(22) Filed: Jun. 7, 2024

(30) Foreign Application Priority Data
Jun. 30, 2023 (JP) 2023-108073

(51) Int. Cl. B65G 1/04; B62D 61/12

(52) U.S. Cl. CPC B65G 1/0492; B62D 61/12

(57) ABSTRACT

An unmanned transport vehicle includes: a plurality of first travel wheels each having an axle extending in a front-back direction; a plurality of second travel wheels each having an axle extending in a left-right direction; and a travel wheel switching mechanism. The unmanned transport vehicle includes a pair of left and right frame bodies that extend in the front-back direction, are respectively supported at intermediate positions by left-right spindles, and swing around the left-right spindles. When traveling with the second travel wheels, the second travel wheels are movable in the up-down direction in accordance with the travel surface. The unmanned transport vehicle includes a frame body swing restriction unit that restricts swing of the frame bodies around the left-right spindles, when the first travel wheels are grounded on the travel surface and the second travel wheels are lifted by the travel wheel switching mechanism.

### BACKGROUND OF THE INVENTION

### Field of the Invention

The present invention relates to an unmanned transport vehicle that travels on a travel surface in a front-back direction and a left-right direction.

### Description of the Background Art

A conventional unmanned transport vehicle that travels on a travel surface in the front-back and left-right directions is provided with: a plurality of first travel wheels each having an axle extending in the front-back direction; a plurality of second travel wheels each having an axle extending in the left-right direction; and a travel wheel switching mechanism that causes either the first travel wheel or the second travel wheel to be grounded on the travel surface, and the other travel wheel to be lifted from the travel surface (refer to PATENT LITERATURE (PTL) 1, for example).

For example, an article moving device 3 disclosed in PTL 1 is provided with: a plurality of X-direction travel wheels 38 each having an axle extending in the Y direction; a plurality of Y-direction travel wheels 48 each having an axle extending in the X-direction; and a travel wheel lifting and lowering means (refer to a travel wheel lifting and lowering unit 40 shown in FIG. 10 regarding the X-direction travel wheel 38). The travel wheel lifting and lowering unit 40 switches the state of the article moving device 3 between a state where the X-direction travel wheels 38 are grounded on a travel surface and the Y-direction travel wheels 48 are lifted as shown in FIG. 13A, and a state where the Y-direction travel wheels 48 are grounded on the travel surface and the X-direction travel wheels 38 are lifted as shown in FIG. 13B.

In order to increase storage efficiency inside a shelf facility having an article storage space, such as an automated warehouse, an unmanned transport vehicle that travels in the front-back and left-right directions in a limited area in the shelf facility, and that moves under an article support member, on which articles are placed, to carry in or out the articles, has been proposed as an example of the aforementioned unmanned transport vehicle (refer to PTL 1, for example).

For example, the article moving device 3 disclosed in PTL 1 is a low floor type device having a low overall height because the article moving device 3 carries in or out articles W while moving under article support members 16a and 16b disposed in sections into which a storage area 7 shown in FIG. 2 is divided by pillars 12a, 12b, 12c, and 12d shown in FIG. 3 and FIG. 11.

### CITATION LIST

### Patent Literature

[PTL 1] Japanese Patent No. 6845980

### SUMMARY

### Technical Problem

The unmanned transport vehicle that travels on the travel surface in the front-back and left-right directions may be configured to also travel on the ground outside the shelf facility, and the travel surface of the ground may have irregularities and spots where the inclination angle changes.

The inventors of the present invention have tried to cause the unmanned transport vehicle to travel on such a travel surface having irregularities and spots where the inclination angle changes. This trial has revealed a problem that traveling performance of the unmanned transport vehicle is degraded on the travel surface having irregularities and spots where the inclination angle changes. In particular, when the unmanned transport vehicle is a low floor type vehicle, reduction in traveling performance on the travel surface having irregularities and spots where the inclination angle changes is remarkable, also because of small diameters of the travel wheels.

An object of the present invention is to improve traveling performance, on a travel surface having irregularities and spots where the inclination angle changes, of an unmanned transport vehicle that travels on the travel surface in the front-back and left-right directions.

### Solution to Problem

An unmanned transport vehicle according to a first aspect of the present invention includes: a plurality of first travel wheels each having an axle extending in a front-back direction; a plurality of second travel wheels each having an axle extending in a left-right direction; a travel wheel switching mechanism that causes one of the first travel wheels and the second travel wheels to be grounded on a travel surface, and an other one of the first travel wheels and the second travel wheels to be lifted from the travel surface in a lifting operation. The unmanned transport vehicle includes a pair of left and right frame bodies extending in the front-back direction, each of the frame bodies being supported at an intermediate position by a left-right spindle, and swinging around the left-right spindle. Some of the second travel wheels are disposed on a front end part and a back end part of the frame body. The unmanned transport vehicle includes a frame body swing restriction unit that restricts swing of each of the frame bodies around the left-right spindle, when the first travel wheels are grounded on the travel surface and the second travel wheels are lifted from the travel surface by the travel wheel switching mechanism.

According to the configuration of the unmanned transport vehicle of the first aspect, one of the first travel wheels and the second travel wheels are grounded on the travel surface and the other travel wheels are lifted from the travel surface by the travel wheel switching mechanism, whereby the unmanned transport vehicle can travel on the travel surface in the front-back and left-right directions.

According to the configuration of the unmanned transport vehicle of the first aspect, the unmanned transport vehicle includes a pair of left and right frame bodies that extend in the front-back direction and swing around the left-right spindles, and some of the second travel wheels are disposed on the front end part and the back end part of the frame body. Therefore, when the unmanned transport vehicle travels with the second travel wheels and the travel surface has irregularities and spots where the inclination angle changes, the pair of left and right frame bodies, in which the second travel wheels are disposed on the front end part and the back end part, individually swing, and the second travel wheels can be moved in the up-down direction with respect to the travel surface. As a result, the traveling performance on the travel surface can be enhanced.

According to the unmanned transport vehicle of the first aspect, when the first travel wheels are grounded on the travel surface and the second travel wheels are lifted from the travel surface by the travel wheel switching mechanism, swing of each frame body, in which the second travel wheels are disposed on the front end part and the back end part, around the left-right spindle is restricted by the frame body swing restriction unit. Therefore, the minimum ground clearance is not reduced due to the swing of the frame bodies with the second travel wheels being lifted from the travel surface. As a result, a desired minimum ground clearance can be maintained.

According to a second aspect of the present invention, in the unmanned transport vehicle according to the first aspect, the frame body swing restriction unit restricts the swing of each frame body when the second travel wheels are moved up, and releases the restriction on the swing of each frame body when the second travel wheels are moved down, in association with the lifting operation of the second travel wheels by the travel wheel switching mechanism.

According to the configuration of the unmanned transport vehicle of the second aspect, the frame body swing restriction unit restricts the swing of the frame body when the second travel wheels are moved up, and releases the restriction on the swing of the frame body when the second travel wheels are moved down, in association with the lifting operation of the second travel wheels by the travel wheel switching mechanism. This configuration eliminates necessity for a large-scale device for restricting the swing of the frame bodies and the release of the restriction, thereby simplifying the configuration of the frame body swing restriction unit.

According to a third aspect of the present invention, in the unmanned transport vehicle according to the second aspect, the frame body swing restriction unit is a positioning part that is disposed in a base supporting the first travel wheels, and abuts against the frame body from above. The positioning part is disposed in a back side of the left-right spindle when the second travel wheels disposed on the front end part and the back end part of the frame body are lifted from the travel surface and the frame body is inclined frontward around the left-right spindle. The positioning part is disposed in a front side of the left-right spindle when the second travel wheels disposed on the front end part and the back end part of the frame body are lifted from the travel surface and the frame body is inclined backward around the left-right spindle.

According to the configuration of the unmanned transport vehicle of the third aspect, the frame body swing restriction unit that operates in association with the lifting operation of the second travel wheels by the travel wheel switching mechanism is the positioning part that is disposed in the base supporting the first travel wheels, abuts against the frame body from above, and is disposed in the front side and the back side of the left-right spindle. Therefore, the configuration of the frame body swing restriction unit is further simplified.

According to a fourth aspect of the present invention, in the unmanned transport vehicle according to the second aspect, the frame body swing restriction unit is the positioning part that is disposed in the base supporting the first travel wheels and abuts against the frame body from above, and the positioning part is disposed in the front side and the back side of the left-right spindle.

According to the configuration of the unmanned transport vehicle of the fourth aspect, the frame body swing restriction unit operating in association with the lifting operation of the second travel wheels by the travel wheel switching mechanism is the positioning part that is disposed in the base supporting the first travel wheels, abuts against the frame body from above, and is disposed on both the front side and back side of the left-right spindle. Therefore, the swing of the frame body around the left-right spindle can be reliably prevented.

According to a fifth aspect of the present invention, in the unmanned transport vehicle according to any one of the first to fourth aspects, the unmanned transport vehicle travels in a shelf facility having an article storage space, and on the ground outside the shelf facility, and in the shelf facility, the unmanned transport vehicle moves under an article support member on which an article is placed, and carries in or out the article. A virtual plane, which abuts, from below, against the second travel wheels disposed on the front end part and the back end part of the frame body, is substantially horizontal, in a state where the swing of the frame body is restricted by the frame body swing restriction unit.

The unmanned transport vehicle according to the fifth aspect includes the travel wheel switching mechanism, and a pair of left and right frame bodies that extend in the front-back direction and each swing around the left-right spindles. In the unmanned transport vehicle, the second travel wheels are disposed on the front end part and the back end part of the frame body. When traveling on the ground outside the shelf facility, the unmanned transport vehicle travels while the second travel wheels are grounded on the travel surface of the ground and the first travel wheels are lifted from the travel surface by the travel wheel switching mechanism. With this operation, even if the travel surface has irregularities and spots where the inclination angle changes, the pair of left and right frame bodies, in each of which the second travel wheels are disposed on the front end part and the back end part, individually swing, whereby the second travel wheels can be moved in the up-down direction with respect to the travel surface. As a result, the traveling performance on the travel surface is enhanced.

The unmanned transport vehicle according to the fifth aspect is a low floor type vehicle having a low overall height because the vehicle moves under the article support member on which the article is placed in the shelf facility and carries in or out the article. Therefore, a lifting stroke cannot be increased when either the first travel wheels or the second travel wheels are grounded on the travel surface and the other travel wheels are lifted from the travel surface by the travel wheel switching mechanism.

According to the unmanned transport vehicle of the fifth aspect, in the state where the first travel wheels are grounded on the travel surface and the second travel wheels are lifted from the travel surface by the travel wheel switching mechanism, and swing of the frame bodies respectively around the left-right spindles is restricted by the frame body swing restriction unit, the virtual plane, which abuts, from below, against the second travel wheels disposed on the front end part and the back end part of the frame body, is substantially horizontal.

Accordingly, the swing of the frame bodies respectively around the left-right spindles is restricted by the frame body swing restriction unit, so that the minimum ground clearance is not reduced due to the swing of the frame bodies with the second travel wheels being lifted from the travel surface, and moreover, the virtual plane, which abuts, from below, against the second travel wheels disposed on the front end part and the back end part of the frame body, is substantially horizontal in the state where the swing of the frame bodies is restricted. As a result, even the low floor type unmanned transport vehicle can maintain a desired minimum ground clearance.

### Advantageous Effects

As described above, according to the unmanned transport vehicle of the present invention, regarding the unmanned transport vehicle that travels on the travel surface in the front-back and left-right directions, it is possible to improve traveling performance on the travel surface having irregularities and spots where the inclination angle changes.

### BRIEF DESCRIPTION OF THE DRAWINGS

FIG. 1 is a schematic plan view of an unmanned transport vehicle according to an embodiment of the present invention;

FIG. 2 is a perspective view of the unmanned transport vehicle in a state where a lifting table is moved down;

FIG. 3 is a perspective view of the unmanned transport vehicle in a state where the lifting table is moved up;

FIG. 4 is a schematic cross-sectional view of the unmanned transport vehicle as seen from the right side, in a state where first travel wheels are grounded on a travel surface with second travel wheels being lifted by a travel wheel switching mechanism;

FIG. 5 is a schematic cross-sectional view of the unmanned transport vehicle as seen from the right side, in a state where the second travel wheels are grounded on the travel surface with the first travel wheels being lifted by the travel wheel switching mechanism;

FIG. 6 is a schematic plan view illustrating major components of a drive system of the unmanned transport vehicle, in a state where a lifting table and covers are removed;

FIG. 7 is an enlarged view of a main part around a right-side sub frame body shown in FIG. 6;

FIG. 8 is a schematic view as seen from the right side, illustrating swing of a frame body extending in a front-back direction; and

FIG. 9 is a schematic view as seen from the right side, illustrating a frame body swing restriction unit.

### DESCRIPTION OF THE PREFERRED EMBODIMENTS

Hereinafter, an embodiment of the present invention will be described based on the drawings. With reference to reference signs in the drawings, an unmanned transport vehicle 1 according to the embodiment of the present invention is provided with a travel wheel switching mechanism C that causes either first travel wheels 11 or second travel wheels 12 to be grounded on a travel surface G, and the other travel wheels to be lifted, and the unmanned transport vehicle 1 can travel on the travel surface G in the front-back and left-right directions.

### [Definition of Direction of Unmanned Transport Vehicle]

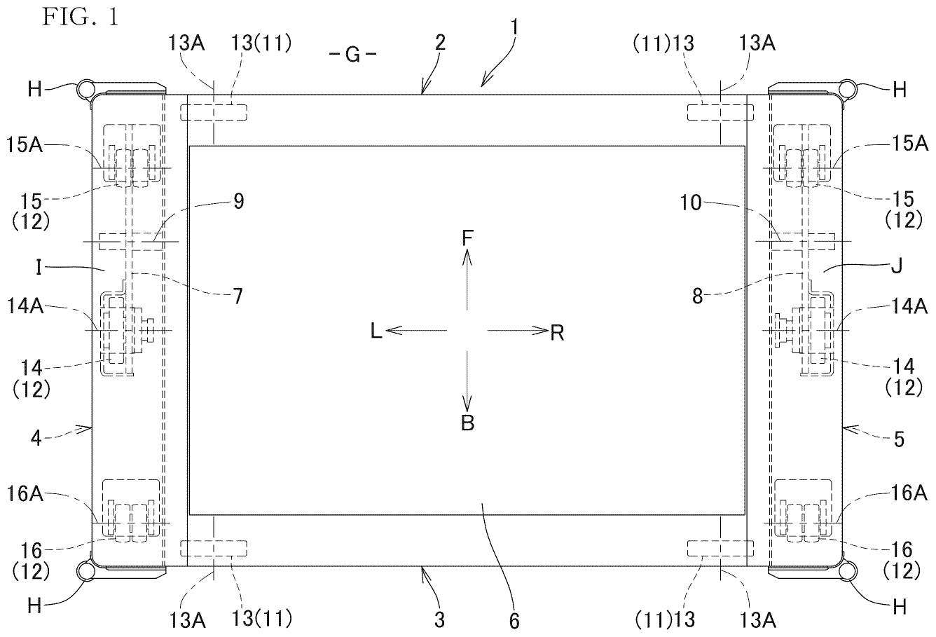

Regarding front-back and left-right directions in the unmanned transport vehicle 1 shown in FIG. 1, an arrow F defines a frontward direction, an arrow B defines a backward direction, an arrow L defines a leftward direction, and an arrow R defines a rightward direction. Each direction includes a direction parallel to the direction. For example, the “frontward direction” includes the direction of the arrow F and a direction parallel to the arrow F, and the “leftward direction” includes the direction of the arrow L and a direction parallel to the arrow L.

### [Definition of Direction of Axle]

Hereinafter, a rotation shaft of each travel wheel included in the unmanned transport vehicle 1 is referred to as an axle. Among the second travel wheels 12, driven wheels 15, 16 are swivel wheels, and are rotatable around a vertical axis. Therefore, the directions of axles 15A, 16A with respect to a vehicle body 2 are changed depending on the traveling state of the unmanned transport vehicle 1.

The direction of the axles 15A, 16A of the driven wheels 15, 16 that are swivel wheels is determined based on the state shown in FIG. 1, i.e., the state in which, for example, the second travel wheels 12 are grounded on the travel surface G with the first travel wheels 11 being lifted by the travel wheel switching mechanism C, left and right driving wheels 14 among the second travel wheels 12 are rotated at the same speed in the same direction, and the unmanned transport vehicle 1 is moved in the frontward direction F. In this reference state, the direction of the axles 15A, 16A of the driven wheels 15, 16 is the left-right direction that is the same as the direction of axles 14A of the driving wheels 14.

### [Unmanned Transport Vehicle]

As shown in FIG. 1, the unmanned transport vehicle 1 according to the embodiment of the present invention is provided with a plurality of first travel wheels 11 each having an axle 13A extending in the front-back direction, and a plurality of second travel wheels 12 having axles 14A, 15A, 16A extending in the left-right direction. The first travel wheels 11 are, for example, four driving wheels 13 in the front-back and left-right directions. The second travel wheels 12 are, for example, two driving wheels 14 in the left-right direction, two driven wheels 15 in the left-right direction, and two driven wheels 16 in the left-right direction.

Among the second travel wheels 12, the driven wheels 15 and the driving wheels 14 are respectively disposed on front end parts and back end parts of a pair of left and right frame bodies 7, 8 extending in the front-back direction. That is, some of the second travel wheels 12 are disposed on the front end parts and the back end parts of the frame bodies 7, 8. The intermediate positions in the front-back direction of the frame bodies 7, 8 are respectively supported by left-right spindles 9, 10, the frame bodies 7, 8 individually swing around the left-right spindles 9, 10.

The number of pairs of left and right frame bodies 7, 8 is not limited to one, and two or more pairs may be provided. There may be a case where two pairs of frame bodies, i.e., two pairs of left and right frame bodies, are provided, and second travel wheels 12 are disposed on the front end parts and the back end parts of these frame bodies while no second travel wheel 12 is disposed anywhere other than the two pairs of left and right frame bodies. Even in such a case, some second travel wheels are disposed on the front end parts and the back end parts of the pairs of left and right frame bodies.

In addition to the pair of left and right frame bodies 7, 8 extending in the front-back direction, a pair of front and back second frame bodies extending in the left-right direction may be provided. The intermediate positions in the left-right direction of the second frame bodies are supported by front-back spindles, so that the second frame bodies individually swing around the front-back spindles. The first travel wheels 11 are disposed on the left end parts and the right end parts of the second frame bodies. Also, the number of pairs of second frame bodies is not limited to one, and two or more pairs may be provided.

The driving wheels 14, among the second travel wheels 12, may not necessarily be disposed in the frame bodies 7, 8, and the driven wheels may be disposed on both the front end parts and the back end parts of the frame bodies 7, 8. The number of pairs of left and right driving wheels 14 is not limited to one, and two or more pairs may be provided. Here, when one pair of left and right driving wheels 14 is disposed in the center in the front-back direction of the vehicle body 2 as shown in FIG. 1 according to the present embodiment, the rotation radius can be reduced by rotating the left and right driving wheels 14 at the same speed in opposite directions to achieve spin turning (on-the-spot turning).

The unmanned transport vehicle 1 has a substantially rectangular shape in a plan view, and includes a main frame body 3 and left and right sub frame bodies 4, 5 which constitute the vehicle body 2, a lifting table 6, and the like. The sub frame bodies 4, 5 and the lifting table 6 are supported by the main frame body 3 so as to be movable up and down. The front end part and the back end part of the left sub frame body 4 are provided with horizontal guide rollers H protruding leftward, and the front end part and the back end part of the right sub frame body 5 are provided with horizontal guide rollers H protruding rightward.

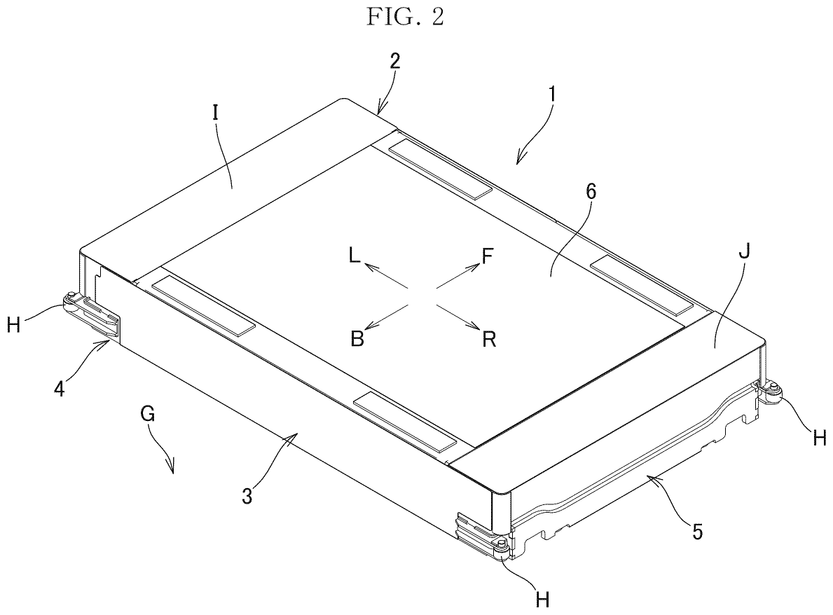

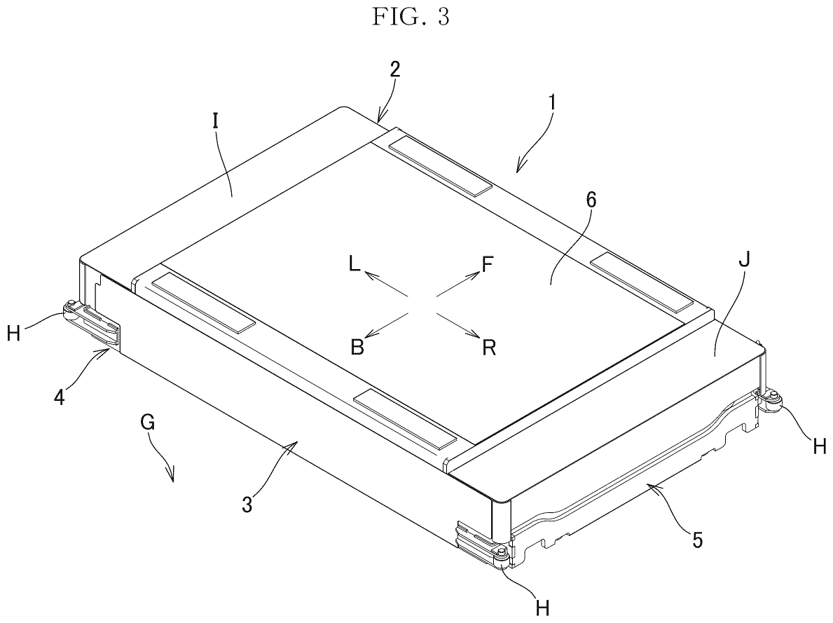

In the present embodiment, the unmanned transport vehicle 1 is a low floor type vehicle having a low overall height, and the lifting table 6 can be moved down as shown in FIG. 2 and moved up as shown in FIG. 3. The lifting table 6 supports an article from below and carries the article.

The low floor type unmanned transport vehicle 1 travels inside the shelf facility having the article storage space as well as on the ground outside the shelf facility. In the shelf facility, the unmanned transport vehicle 1 is suitable for carrying in or out articles while moving under the article support member on which articles are placed. The unmanned transport vehicle 1 may travel only on the ground outside the shelf facility, and may be suitable for, for example, performing a predetermined work while moving under a cart, a palette platform, or the like present on the ground outside the shelf facility. Note that the phrase “on the ground” means not only “on the land” but also “on a floor” and the like.

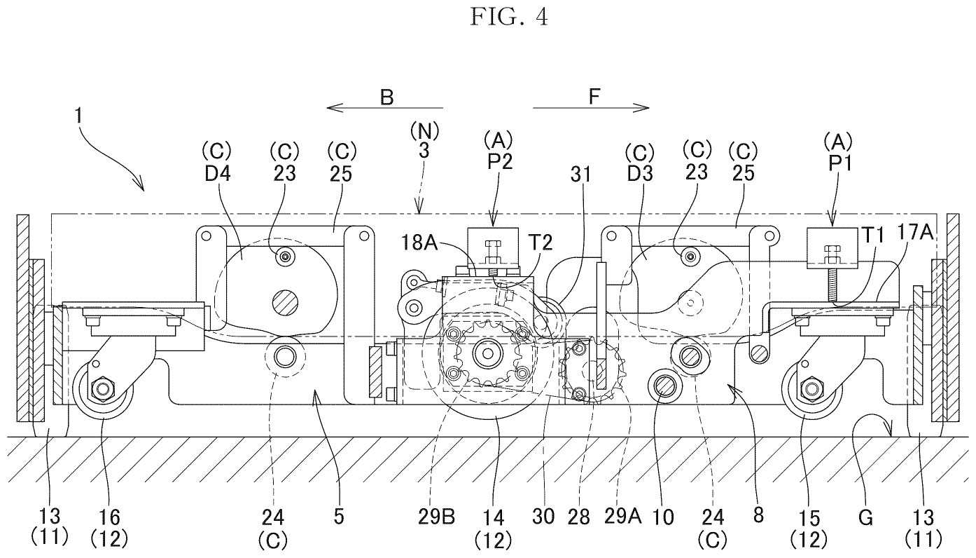

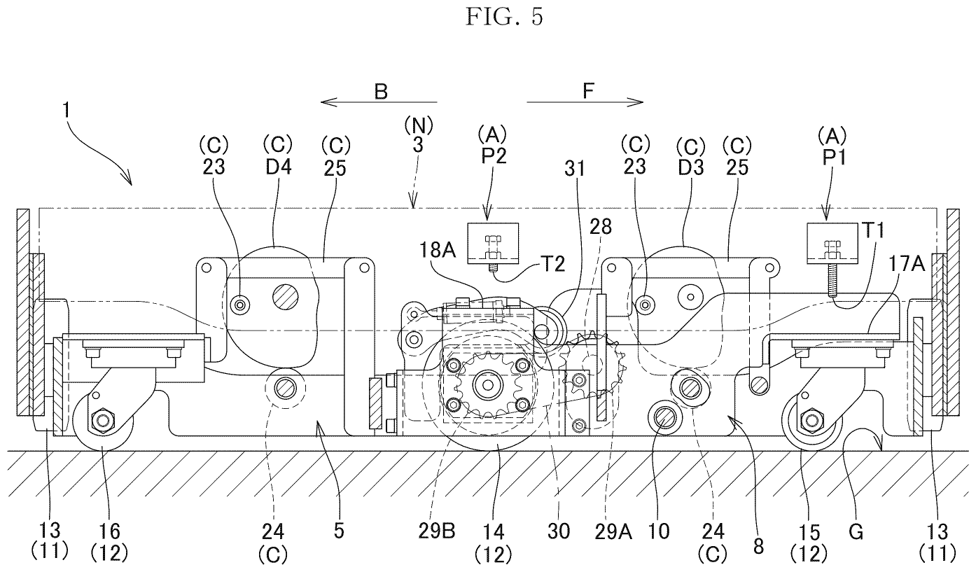

Since the unmanned transport vehicle 1 is provided with the travel wheel switching mechanism C as described above, the state of the unmanned transport vehicle 1 can be switched by the travel wheel switching mechanism C between the state where the first travel wheels 11 are grounded on the travel surface G with the second travel wheels 12 being lifted as shown in FIG. 4 and the state where the second travel wheels 12 are grounded on the travel surface G with the first travel wheels 11 being lifted as shown in FIG. 5. The unmanned transport vehicle 1 travels with the first travel wheels 11 when the first travel wheels 11 are grounded on the travel surface G, and travels with the second travel wheels 12 when the second travel wheels 12 are grounded on the travel surface G.

### [Example of Configuration of Drive System]

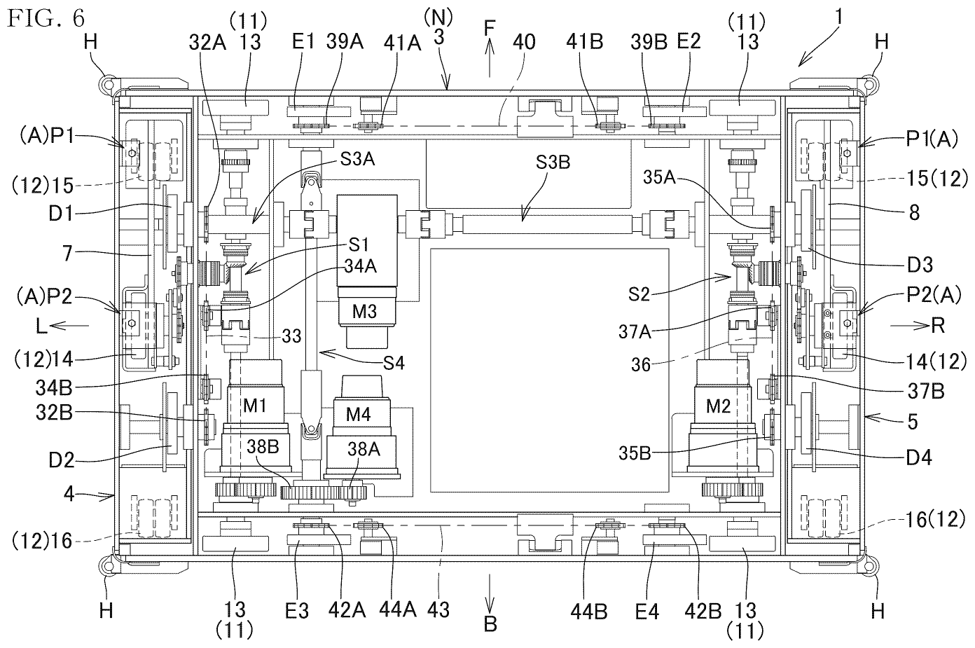

A schematic plan view shown in FIG. 6 in which the lifting table 6 and covers I, J shown in FIGS. 1 to 3 are removed, is referred to. FIG. 6 shows major components of the drive system of the unmanned transport vehicle 1. The main frame body 3 is provided with traveling drive devices M1, M2, a travel wheel switching mechanism drive device M3, and a lifting drive device M4. These drive devices M1, M2, M3, M4 are, for example, geared motors.

### (Drive System by Traveling Drive Device)

The traveling drive device M1 drives two driving wheels 13, i.e., the left-front and left-back driving wheels 13, among the first travel wheels 11, and the left driving wheel 14 among the second travel wheels 12. The traveling drive device M2 drives two driving wheels 13, i.e., the right-front and right-back driving wheels 13 among the first travel wheels 11, and the right driving wheel 14 among the second travel wheels 12.

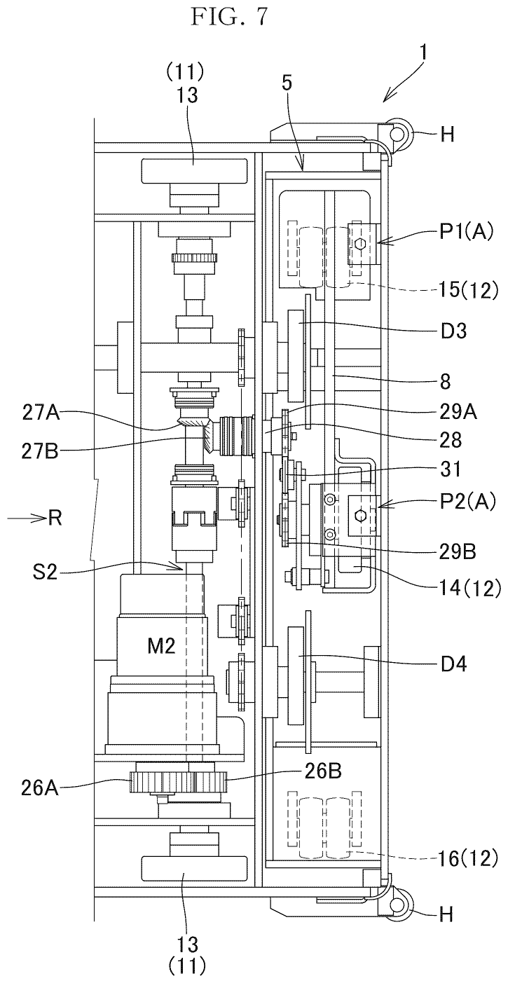

First, a driving torque transmission mechanism of the traveling drive device M2 will be described with reference to FIG. 7. The driving torque of the traveling drive device M2 is transmitted to a second shaft S2 extending in the front-back direction by spur gears 26A, 26B, and thus the second shaft S2 rotates. The rotation of the second shaft S2 causes the right-front and right-back driving wheels 13 to rotate.

Furthermore, a bevel gear 27A attached to the intermediate position in the front-back direction of the second shaft S2 causes a bevel gear 27B to rotate, whereby a shaft 28 extending in the left-right direction rotates. The rotation of the shaft 28 causes the driving torque to be transmitted by a sprocket 29A, a chain 30, and a sprocket 29B shown in FIG. 4 and FIG. 5, whereby the right driving wheel 14 rotates. Since a tension roller 31 is elastically biased to the chain 30, the tension of the chain 30 is ensured.

A driving torque of the traveling drive device M1 is transmitted to a first shaft S1 extending in the front-back direction through the same transmission mechanism as the driving torque transmission mechanism of the traveling drive device M2, whereby the left-front and left-back driving wheels 13 and the left driving wheel 14 rotate.

### (Drive System of Travel Wheel Switching Mechanism Drive Device)

The travel wheel switching mechanism drive device M3 shown in FIG. 6 is of a dual-output type, and a driving torque thereof is transmitted to a third left shaft S3A and a third right shaft S3B, whereby a left-front switch cam D1 and a right-front switch cam D3 are driven.

Since the driving torque is transmitted by a sprocket 32A attached to the third left shaft S3A, a chain 33, and a sprocket 32B, a left-back switch cam D2 is driven. Note that the tension of the chain 33 can be adjusted by idler sprockets 34A, 34B.

Since the driving torque is transmitted by a sprocket 35A attached to the third right shaft S3B, a chain 36, and a sprocket 35B, a right-back switch cam D4 is driven. Note that the tension of the chain 36 can be adjusted by idler sprockets 37A, 37B.

As described above, the switch cams D1 to D4 can be rotated by driving the travel wheel switching mechanism drive device M3.

At the rotation positions of the switch cams D3, D4 shown in FIG. 4 (also at the rotation positions of the switch cams D1, D2), a hanger 25 is pushed up by a roller 23, so that the sub frame body 5 (also the sub frame body 4) is moved up with respect to the main frame body 3, whereby the second travel wheels 12 are lifted and the first travel wheels 11 are grounded on the travel surface G.

Meanwhile, at the rotation positions of the switch cams D3, D4 shown in FIG. 5 (also at the rotation positions of the switch cams D1, D2), a cam follower 24 is pushed down by the switch cams D1 to D4, so that the sub frame body 5 (also the sub frame body 4) moves down with respect to the main frame body 3, whereby the first travel wheels 11 are lifted and the second travel wheels 12 are grounded on the travel surface G.

The travel wheel switching mechanism drive device M3 and its drive system, the switch cams D1 to D4, the roller 23, the hanger 25, and the cam follower 24 constitute the travel wheel switching mechanism C that causes either the first travel wheels 11 or the second travel wheels 12 to be grounded, and the other travel wheels to be lifted.

### (Drive System of Lifting Drive Device)

Since a driving torque of the lifting drive device M4 shown in FIG. 6 is transmitted to a fourth shaft S4 extending in the front-back direction by spur gears 38A, 38B, a left-front lifting cam E1 and a left-back lifting cam E3 are driven.

Since the driving torque is transmitted by a sprocket 39A attached to a front part of the fourth shaft S4, a chain 40, and a sprocket 39B, a right-front lifting cam E2 is driven. Note that the tension of the chain 40 can be adjusted by idler sprockets 41A, 41B.

Since the driving torque is transmitted by a sprocket 42A attached to a back part of the fourth shaft S4, a chain 43, and a sprocket 42B, a right-back lifting cam E4 is driven. Note that the tension of the chain 43 can be adjusted by idler sprockets 44A, 44B.

As described above, the lifting cams E1 to E4 can be rotated by driving the lifting drive device M4. Thus, the lifting table 6 can be moved down as shown in FIG. 2, and moved up as shown in FIG. 3.

### [Frame Body, and Second Travel Wheels Disposed at Front and Back Parts of the Frame Body]

With reference to FIG. 1, as described above, the unmanned transport vehicle 1 includes the pair of left and right frame bodies 7, 8 that individually swing around the left-right spindles 9, 10, and the second travel wheels 12 are disposed at the front end parts and the back end parts of the frame bodies 7, 8.

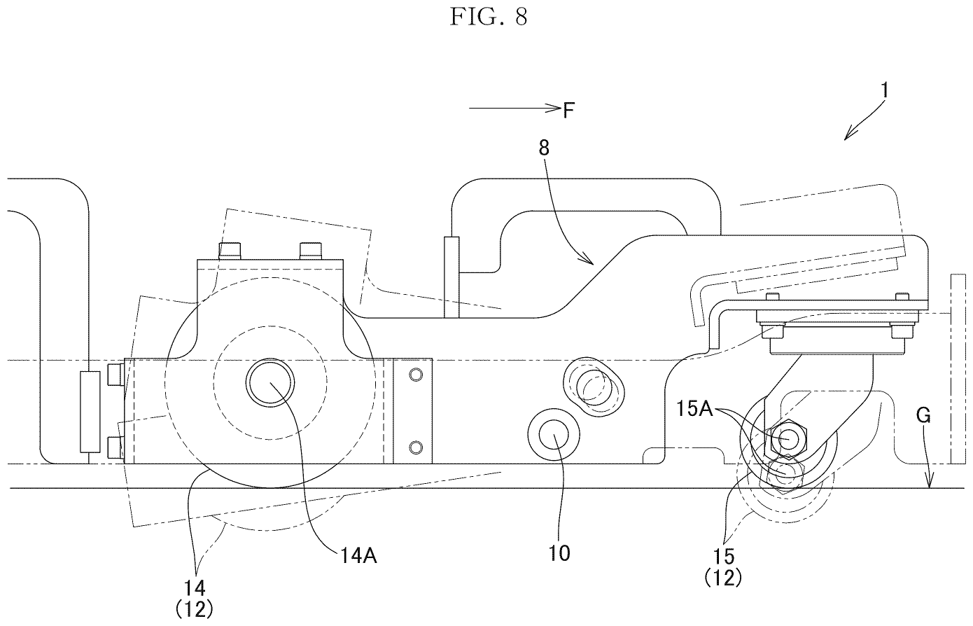

Therefore, when the unmanned transport vehicle 1 travels with the second travel wheels 12 in the state where the second travel wheels 12 are grounded on the travel surface G with the first travel wheels 11 being lifted by the travel wheel switching mechanism C as shown in FIG. 5, the right frame body 8 swings around the left-right spindle 10, and the front and back second travel wheels 12 in the right frame body 8 move in the up-down direction, in accordance with the travel surface G, as shown in FIG. 8. Likewise, the left frame body 7 swings around the left-right spindle 9 independently from the right frame body 8, and the front and back second travel wheels 12 in the left frame body 7 move in the up-down direction, in accordance with the travel surface G.

Therefore, even if the unmanned transport vehicle 1 travels with the second travel wheels 12 on the travel surface G having irregularities and spots where the inclination angle changes, the traveling performance on the travel surface G can be improved.

The travel surface G, on which the unmanned transport vehicle 1 travels with the second travel wheels 12, may be a horizontal surface having no irregularities. Even in such a case, if the number of the second travel wheels 12 of the unmanned transport vehicle 1 is four or more (three wheels can be stably grounded) as in the present embodiment, it is sometimes difficult to ground all the wheels due to manufacturing errors, and the like upon mounting the wheels. Even in such a case, all the wheels can be grounded by disposing the travel wheels 12 on the front end parts and the back end parts of the paired left and right frame bodies 7, 8 that individually swing around the left-right spindles 9, 10.

### [Frame Body Swing Restriction Unit]

The unmanned transport vehicle 1 includes a frame body swing restriction unit A that restricts swing of the frame bodies 7, 8 around the left-right spindles 9, 10, when the state of the unmanned transport vehicle 1 is switched by the travel wheel switching mechanism C from the state where the second travel wheels 12 are grounded on the travel surface G with the first travel wheels 11 being lifted as shown in FIG. 5, to the state where the first travel wheels 11 are grounded on the travel surface G with the second travel wheels 12 being lifted as shown in FIG. 4.

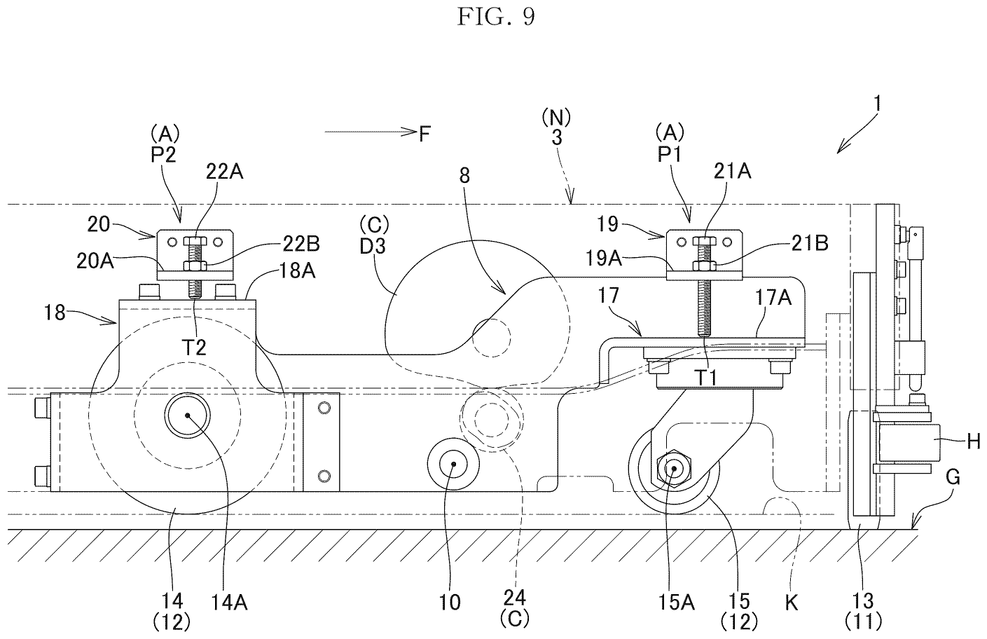

The frame body swing restriction unit A is, for example, positioning parts P1, P2, shown in FIG. 6 and FIG. 9, which are disposed on a main frame 3 serving as a base N supporting the first travel wheels 11, and abut against the frame bodies 7, 8 from above. The positioning parts P1 are disposed in the frontward direction F with respect to the left-right spindles 9, 10 (refer to FIG. 1), and the positioning parts P2 are disposed in the backward direction B with respect to the left-right spindles 9, 10.

Each positioning part P1 is composed of: a bolt 21A, in the up-down direction, which is screwed in a screw hole formed in a horizontal plate 19A of a support bracket 19; and a nut 21B through which the bolt 21A is screwed and which abuts against the upper surface of the horizontal plate 19A. With the nut 21B being loosened, the bolt 21A is rotated to adjust the length of the screw part that protrudes downward from the lower surface of the horizontal plate 19A (the position of a tip T1 of the screw part of the bolt 21A). After adjusting the position of the tip T1 of the screw part of the bolt 21A, the nut 21B is tightened and pressed to the upper surface of the horizontal plate 19A, thereby fixing the position of the bolt 21A with respect to the support bracket 19.

Each positioning part P2 is composed of: a bolt 22A which extends in the up-down direction, and is screwed in a screw hole formed in a horizontal plate 20A of a support bracket 20; and a nut 22B through which the bolt 22A is screwed and which abuts against the upper surface of the horizontal plate 20A. With the nut 22B being loosened, the bolt 22A is rotated to adjust the length of the screw part that protrudes downward from the lower surface of the horizontal plate 20A (the position of a tip T2 of the screw part of the bolt 22A). After adjusting the position of the tip T2 of the screw part of the bolt 22A, the nut 22B is tightened and pressed to the upper surface of the horizontal plate 20A, thereby fixing the position of the bolt 22A with respect to the support bracket 20.

When the travel wheel switching mechanism C has switched the state of the unmanned transport vehicle 1 from the state shown in FIG. 5 to the state shown in FIG. 4 and thereby the second travel wheels 12 move up, the tip T1 of the screw part of the bolt 21A comes close to an upper surface 17A of a front end part support member 17 of the frame body 7, 8 as shown in FIG. 9, and the tip T2 of the screw part of the bolt 22A comes close to an upper surface 18A of a back end part support member 18 of the frame body 7, 8. In this state, swing of the frame bodies 7, 8 around the left-right spindles 9, 10 is restricted, and the frame body swing restriction unit A is in its operating state.

In the operating state of the frame body swing restriction unit A shown in FIG. 9, regarding the front opposing faces of the tip T1 of the screw part of the bolt 21A and the upper surface 17A of the front end part support member 17 and the back opposing faces of the tip T2 of the screw part of the bolt 22A and the upper surface 18A of the back end part support member 18, the positions of the bolts 21A, 22A are adjusted so that not both of the front opposing faces and the back opposing faces are in the contact states. This prevents overload when the frame body swing restriction unit A is in the operating state.

At the front opposing faces, the tip T1 of the screw part of the bolt 21A or the upper surface 17A of the front end part support member 17, and the tip T2 of the screw part of the bolt 22A or the upper surface 18A of the back end part support member 18, may be provided with an elastic material such as rubber. In this case, in the operating state of the frame body swing restriction unit A shown in FIG. 9, the tip T1 of the screw part of the bolt 21A is brought into contact with the upper surface 17A of the front end part support member 17 via the elastic material, and the tip T2 of the screw part of the bolt 22A is brought into contact with the upper surface 18A of the back end part support member 18 via the elastic material. This prevents the frame bodies 7, 8 from rattling while preventing overload due to deformation of the elastic material. As a result, noise and the like during traveling with the first travel wheels 11 can be avoided.

When the travel wheel switching mechanism C has switched the state of the unmanned transport vehicle 1 from the state shown in FIG. 4 to the state shown in FIG. 5 and thereby the second travel wheels 12 move down, the tip T1 of the screw part of the bolt 21A is separated from the upper surface 17A of the front end part support member 17 of the frame body 7, 8, and the tip T2 of the screw part of the bolt 22A is separated from the upper surface 18A of the back end part support member 18 of the frame body 7, 8. In this state, restriction on swing of the frame bodies 7, 8 around the left-right spindles 9, 10 is released, and the frame body swing restriction unit A is in its non-operating state.

As described above, in association with the lifting operation of the second travel wheels controlled by the travel wheel switching mechanism C, the frame body swing restriction unit A restricts swing of the frame bodies 7, 8 around the left-right spindles 9, 10 when the second travel wheels 12 are moved up, and releases the restriction on swing of the frame bodies 7, 8 when the second travel wheels 12 are moved down. This configuration eliminates necessity for a large-scale device for restricting swing of the frame bodies 7, 8 and releasing the restriction, thereby simplifying the configuration of the frame body swing restriction unit A.

Moreover, as shown in FIG. 6 and FIG. 9, the frame body swing restriction unit A is composed of the positioning parts P1, P2 which abut against the frame bodies 7, 8 from above, and are disposed in both the frontward direction F and the backward direction B with respect to the left-right spindles 9, 10. As a result, swing of the frame bodies 7, 8 around the left-right spindles 9, 10 can be reliably prevented.

In the above embodiment, the positioning parts P1, P2 are disposed in both the frontward direction F and the backward direction B with respect to the left-right spindles 9, 10. However, the positioning part may be disposed in only one of the frontward direction F and the backward direction B with respect to the left-right spindles 9, 10.

In such a configuration, if the second travel wheels 12 disposed on the front end parts and the back end parts of the frame bodies 7, 8 are lifted from the travel surface G and thus the frame bodies 7, 8 are inclined backward around the left-right spindles 9, 10, the positioning parts P1 in the frontward direction F with respect to the left-right spindles 9, 10 are provided. In the present embodiment, the driving wheels 14 are present on the back end parts of the frame bodies 7, 8, and are heavier than the driven wheels 15 on the front end parts of the frame bodies 7, 8, which corresponds to the case where the frame bodies 7, 8 are inclined backward. If the second travel wheels 12 disposed on the front end parts and the back end parts of the frame bodies 7, 8 are lifted from the travel surface G, and thus the frame bodies 7, 8 are inclined frontward around the left-right spindles 9, 10, the positioning parts P2 in the backward direction B with respect to the left-right spindles 9, 10 are provided.

In the case where the positioning parts are disposed in only one of the frontward direction F and the backward direction B with respect to the left-right spindles 9, 10 to provide the frame body swing restriction unit A, the configuration of the frame body swing restriction unit A is more simplified.

The configuration of the frame body swing restriction unit A is not limited to the positioning parts P1 and/or P2 as described above. The frame body swing restriction unit A may have any configuration as long as it has the function of restricting swing of the frame bodies 7, 8 around the left-right spindles 9, 10 when the first travel wheels 11 are grounded on the travel surface G and the second travel wheels 12 are lifted by the travel wheel switching mechanism C.

For example, in the present embodiment, the driving wheels 14 are provided on the back end parts of the frame bodies 7, 8 and are heavier than the driven wheels 15 on the front end parts of the frame bodies 7, 8. Accordingly, the frame bodies 7, 8 are inclined backward around the left-right spindles 9, 10 when the second travel wheels 12 are lifted from the travel surface G. Therefore, an clastic biasing force of a tension coil spring or the like may be used to pull the frame bodies 7, 8 upward at positions in the backward direction B with respect to the left-right spindles 9, 10. In this case, when the first travel wheels 11 are grounded on the travel surface G and the second travel wheels 12 are lifted, by the travel wheel switching mechanism C, positioning is performed by disposing the positioning parts in the backward direction B with respect to the left-right spindles 9, 10 of the frame bodies 7, 8 pulled upward by the clastic urging force, to provide the frame body swing restriction unit A.

Alternatively, a mechanism, which locks the left-right spindles 9, 10 with respect to the frame bodies 7, 8 at a certain point in time before upward movement of the second travel wheels 12 until completion of the upward movement when the second travel wheels 12 are lifted, may be provided as the frame body swing restriction unit A.

The unmanned transport vehicle 1 is provided with the frame body swing restriction unit A as described above, to restrict swing of the frame bodies 7, 8, in which the second travel wheels 12 are disposed on the front end parts and the back end parts, around the left-right spindles 9, 10, at a time when the first travel wheels 11 are grounded on the travel surface G and the second travel wheels 12 are lifted from the travel surface G by the travel wheel switching mechanism C. Therefore, the minimum ground clearance (a vertical distance from the horizontal ground surface to the lowest part of the vehicle body) is not reduced due to swing of the frame bodies 7, 8 with the second travel wheels 12 being lifted from the travel surface G. As a result, a desired minimum ground clearance can be maintained.

When the unmanned transport vehicle 1 is a low floor type vehicle having a low overall height as shown in FIG. 2 and FIG. 3, the lifting stroke cannot be increased when either the first travel wheels 11 or the second travel wheels 12 are grounded on the travel surface G and the other travel wheels are lifted by the travel wheel switching mechanism C.

In the present embodiment, when the frame body swing restriction unit A is in the operating state shown in FIG. 9, a virtual plane K, which abuts, from below, against the second travel wheels 12 disposed on the front end parts and the back end parts of the frame bodies 7, 8, is substantially horizontal.

Therefore, in the case where the unmanned transport vehicle 1 travels in the shelf facility having the article storage space and on the ground outside the shelf facility, and in the shelf facility, moves under the article support member on which articles are placed to carry in or out the articles, it is possible for the low floor type unmanned transport vehicle 1 to maintain a desired minimum ground clearance while improving the article storage efficiency.

The foregoing description of the embodiment is in all aspects illustrative and not restrictive. It will be understood that numerous other modifications and variations can be devised without departing from the scope of the invention.

What is claimed is:

1. An unmanned transport vehicle comprising:
a plurality of first travel wheels each having an axle extending in a front-back direction;
a plurality of second travel wheels each having an axle extending in a left-right direction;
a travel wheel switching mechanism that causes one of the first travel wheels and the second travel wheels to be grounded on a travel surface, and an other one of the first travel wheels and the second travel wheels to be lifted from the travel surface in a lifting operation; and
a pair of left and right frame bodies extending in the front-back direction, each of the frame bodies being supported at an intermediate position by a left-right spindle, and swinging around the left-right spindle, the frame body having a front end part and a back end part, on which some of the second travel wheels are disposed; and
a frame body swing restriction unit that restricts swing of each of the frame bodies around the left-right spindle, when the first travel wheels are grounded on the travel surface and the second travel wheels are lifted from the travel surface by the travel wheel switching mechanism.

2. The unmanned transport vehicle according to claim 1, wherein
in association with the lifting operation of the second travel wheels by the travel wheel switching mechanism,
the frame body swing restriction unit restricts the swing of each of frame bodies when the second travel wheels are moved up, and
releases the restriction on the swing of each of the frame bodies when the second travel wheels are moved down.

3. The unmanned transport vehicle according to claim 2, wherein
the frame body swing restriction unit is a positioning part that is disposed in a base supporting the first travel wheels, and abuts against the frame body from above, and
the positioning part is:
disposed in a back side of the left-right spindle when the second travel wheels disposed on the front end part and the back end part of the frame body are lifted from the travel surface and the frame body is inclined frontward around the left-right spindle; and
disposed in a front side of the left-right spindle when the second travel wheels disposed on the front end part and the back end part of the frame body are lifted from the travel surface and the frame body is inclined backward around the left-right spindle.

4. The unmanned transport vehicle according to claim 2, wherein
the frame body swing restriction unit is a positioning part that is disposed in a base supporting the first travel wheels, and abuts against the frame body from above, and
the positioning part is disposed in a front side and a back side of the left-right spindle.

5. The unmanned transport vehicle according to claim 1, wherein
the unmanned transport vehicle travels in a shelf facility having an article storage space, and on the ground outside the shelf facility,
in the shelf facility, the unmanned transport vehicle moves under an article support member on which an article is placed, and carries in or out the article, and
a virtual plane, which abuts, from below, against the second travel wheels disposed on the front end part and the back end part of the frame body, is substantially horizontal, in a state where the swing of the frame body is restricted by the frame body swing restriction unit.
